(19) United States
(12) Patent Application Publication
(10) Pub. No.: US 2013/0187360 A1
(43) Pub. Date: Jul. 25, 2013

(54) AXLE FOR A STEERING ARRANGEMENT

(71) Applicants: Steven D. Springer, Aurora, IL (US); Bruno L. Risatti, Lemont, IL (US)

(72) Inventors: Steven D. Springer, Aurora, IL (US); Bruno L. Risatti, Lemont, IL (US)

(73) Assignee: Caterpillar Inc., Peoria, IL (US)

(21) Appl. No.: 13/354,862

(22) Filed: Jan. 20, 2012

(51) Int. Cl. B62D 53/02; B60B 35/16

(52) U.S. Cl. 280/400; 301/137

(57) ABSTRACT

An axle for providing a steering arrangement in a machine. The axle including a differential housing from which a first arm and a second arm are extending. A first support portion is disposed in the first arm. The first support portion is configured to receive a first steering actuator. Similarly, a second support portion is disposed in the second arm. The second support portion is configured to receive a second steering actuator.

### TECHNICAL FIELD

The present disclosure relates to a steering arrangement in a machine and more particularly to an axle for the steering arrangement.

### BACKGROUND

Machines, such as, a wheel loader, typically have a frame divided into a front frame member and a rear frame member, and an articulated joint providing a connection between the front frame member and the rear frame member. Typically, to steer such machines, the front frame member is rotated relative to the rear frame member about the articulated joint. To rotate the front frame member, a pair of steering actuators is disposed between the front frame member and the rear frame member. The pair of steering actuators is connected from one end to the rear frame member and from other end to the front frame member. On receiving operator command, the pair of steering actuators is actuated to extend or retract, causing the front frame member to rotate relative to the rear frame member.

### SUMMARY

In one aspect, the present disclosure provides an axle for a steering arrangement in a machine. The axle including a differential housing from which a first arm and a second arm are extending. Further, a first support portion is disposed in the first arm. The first support portion is configured to receive a first steering actuator in the steering arrangement. Similarly, a second support portion is disposed in the second arm. The second support portion is configured to receive a second steering actuator in the steering arrangement.

In another aspect, the present disclosure provides a chassis having a front frame member and a rear frame member, and an articulation joint for connecting the front frame member and the rear frame member. Further, an axle is provided having the first arm and the second arm. Also, the first support portion is disposed in the first arm. The first support portion is configured to receive the first steering actuator. And, the second support portion is disposed in the second arm. The second support portion is configured to receive the second steering actuator.

In yet another aspect, the present disclosure provides a machine having a pair of wheels acting as ground engaging members. The machine includes an axle disposed between the pair of wheels. The axle includes the first arm and the second arm. Further, a first support portion is disposed in the first arm. Also, the second support portion is disposed in the second arm. The frame is supported on the axle and includes the front frame member and the rear frame member. The articulation joint connects the front frame member and the rear frame member. The first steering actuator is pivotally connected to the first support portion and the rear frame member. Similarly, the second steering actuator is pivotally connected to the second support portion and the rear frame member.

Other features and aspects of this disclosure will be apparent from the following description and the accompanying drawings.

### BRIEF DESCRIPTION OF THE DRAWINGS

FIG. 1 illustrates a partial perspective view of a machine;

FIG. 2 illustrates a top perspective view of a chassis for the machine of FIG. 1;

FIG. 3 illustrates a bottom perspective view of the chassis with a steering arrangement;

FIG. 4 illustrates a perspective view of an axle, according to an embodiment of the present disclosure;

FIG. 5 illustrates a perspective view of an axle, according to another embodiment of the present disclosure;

FIG. 6 illustrates a top view of the axle, according to an aspect of the present disclosure; and

FIG. 7 illustrates a side view of the axle, according to an aspect of the present disclosure.

### DETAILED DESCRIPTION

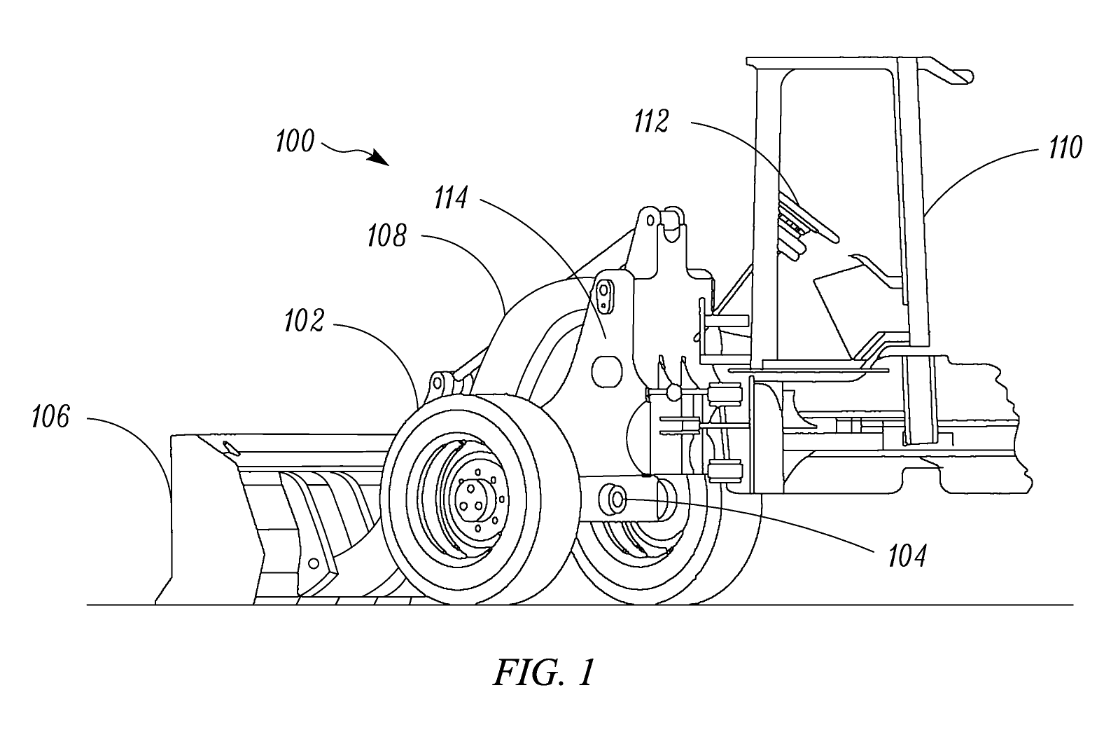

The present disclosure will now be described in detail with reference being made to accompanying figures. A machine 100 in which disclosed embodiments may be implemented is schematically illustrated in FIG. 1. The machine 100 may be generically described as any machine using an articulated steering system, that is, a relative motion between the fore and aft for steering purpose. In the accompanied drawings, the machine 100 is illustrated as a wheel loader. However, the machine 100 may be any earth moving machine used for industries like mining or construction, for example, a wheel loader, an excavator, a motor grader, a cold planer, a front loader, a backhoe loader, or the like.

The machine 100 may include a power source (not illustrated) to drive or propel the machine 100. The power source may be an internal combustion engine like a gasoline, diesel or natural gas engine, an electrical source like a series of batteries, an overhead conductor, etc. The machine 100 may further include a pair of wheels 102 acting as the ground engaging members and an axle 104 disposed therebetween. The machine 100 may also include a bucket 106, which may be used to scoop and lift material. The bucket 106 may be mounted by means of a linkage arm 108. The linkage arm 108 may be hydraulically controlled to lift and tilt the bucket 106.

An operator cab, illustrated as 110, may be provided in the machine 100 in the form of an enclosure. The operator cab 110 may include controls necessary to operate the machine 100. In particular, the operator cab 110 may include steering control 112 for issuing commands to steer the machine 100. The steering control 112 may be in the form of a steering wheel, dials, levers, touch based user interface, etc. The steering control 112 may be used by an operator to generate a steering signal. The steering signal may be configured to steer the machine 100 in either right or left direction, as required by the operator.

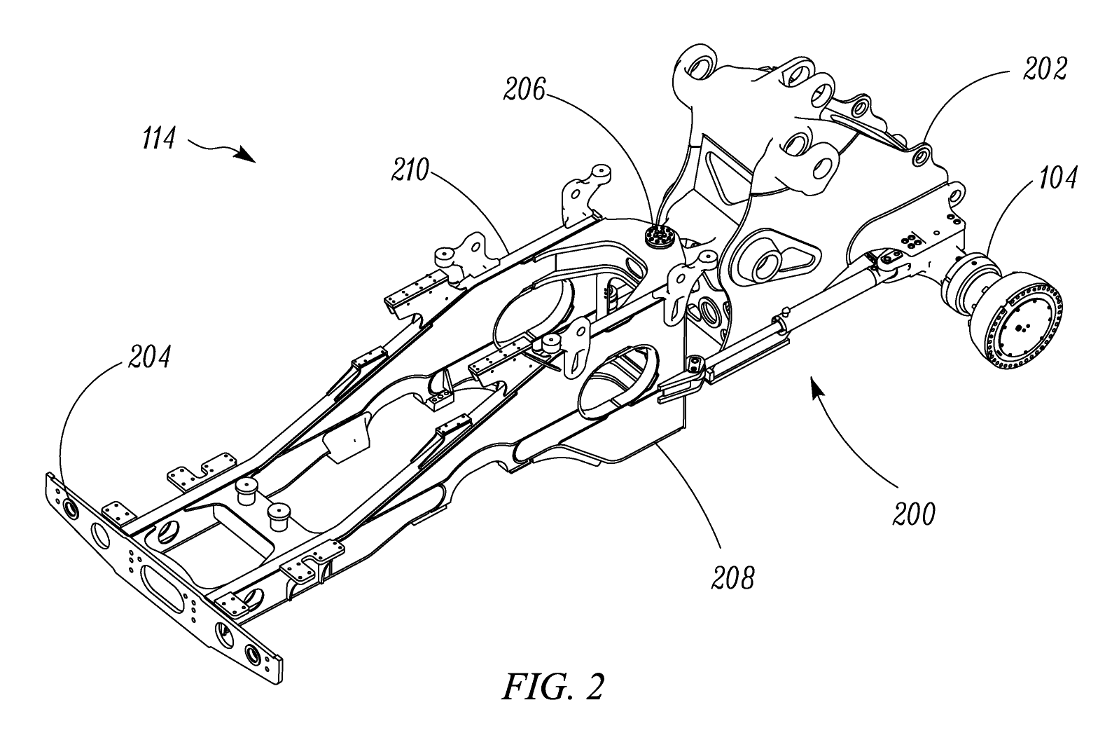

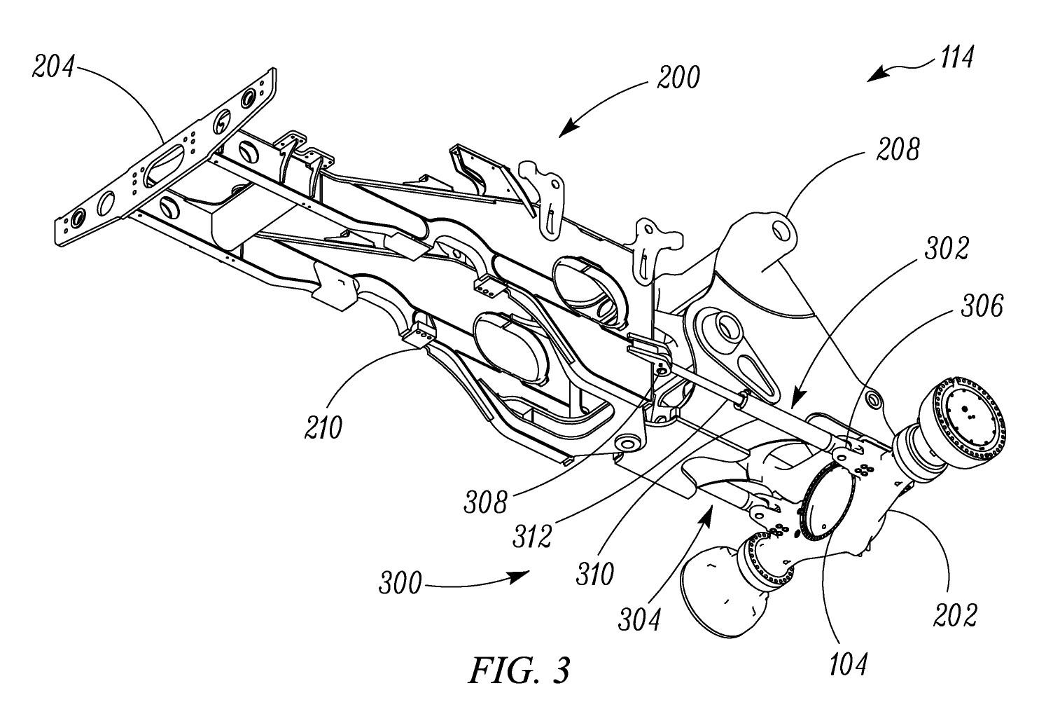

The machine 100 may further include a chassis 114 supported on the pair of wheels 102. The axle 104 may be formed along with the chassis 114 in the machine 100. FIGS. 2-3 illustrate different perspective views of the chassis 114. The chassis 114 may be extending between the fore and aft of the machine 100. The chassis 114 may be formed by casting out as a single structure or alternatively as multiple structures connected together by some means. In an embodiment, the machine 100 of the present disclosure may provide a unibody structure with the body of the machine 100 formed along with the chassis 114 during manufacturing.

The chassis 114 may provide a frame 200 to install various components in the machine 100. The frame 200 may be characterized as being long, wide and flat and be divided into a front frame member 202 and a rear frame member 204. Further, the frame 200 may be extending between a first side 208 and a second side 210 of the chassis 114. In an embodiment, the frame 200 may include an articulation joint 206 to pivotally connect the front frame member 202 and the rear frame member 204. The articulation joint 206 allows the front frame member 202 to rotate relative to the rear frame member 204 to achieve steering in the machine 100.

As illustrated, the front frame member 202 may be supported on the axle 104. The front frame member 202 may provide means to mount the linkage arm 108 in the machine 100. However, it may be apparent that the linkage arm 108 may be mounted on the rear frame member 204 as readily, such as in a backhoe loader, for different applications of the machine 100. Further, the rear frame member 204 may provide space to install the power source. Typically, the operator cab 110 is also disposed on the rear frame member 204 in the machine 100.

Referring now to FIG. 3, the machine 100 may provide a steering arrangement 300 having a pair of steering actuators, a first steering actuator 302 and a second steering actuator 304. As readily understood by a person ordinarily skilled in the art, the first steering actuator 302 may be located towards the first side 208 of the chassis 114 and the second steering actuator 304 towards the second side 210 of the chassis 114. The steering actuators 302, 304 may be disposed between the front frame member 202 and the rear frame member 204 in the machine 100, more clearly illustrated in FIG. 3. Specifically, the steering actuators 302, 304 may be connected to the front frame member 202 at a first end 306 and the rear frame member 204 at a second end 308.

In an embodiment, the steering actuators 302, 304 may be hydraulic actuators having a cylinder 310 and an extendable rod 312 disposed in the cylinder 310. The extendable rod 312 may be configured to move linearly in the cylinder 310. The steering actuators 302, 304 may be connected to a hydraulic circuit (not illustrated) in the machine 100. The hydraulic circuit may supply a hydraulic fluid to the steering actuators 302, 304 based at least in part on the steering signal. Alternatively, the steering actuators 302, 304 may be linear motors having a screw or the like to move linearly on receiving the steering signal.

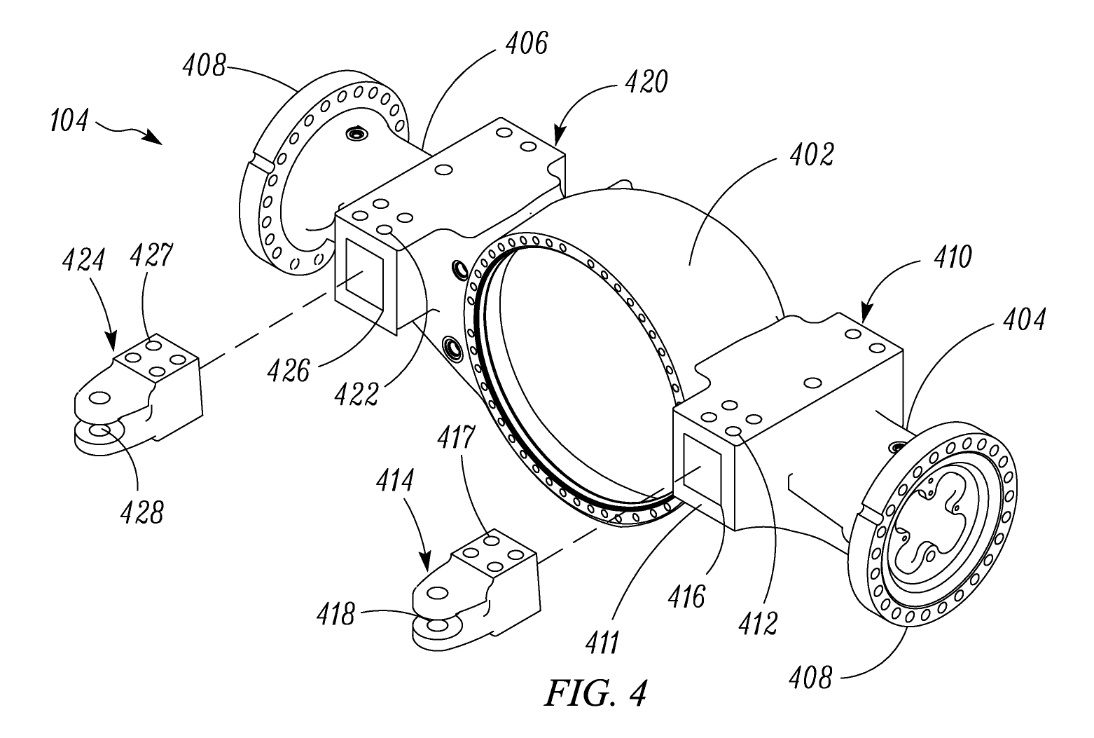

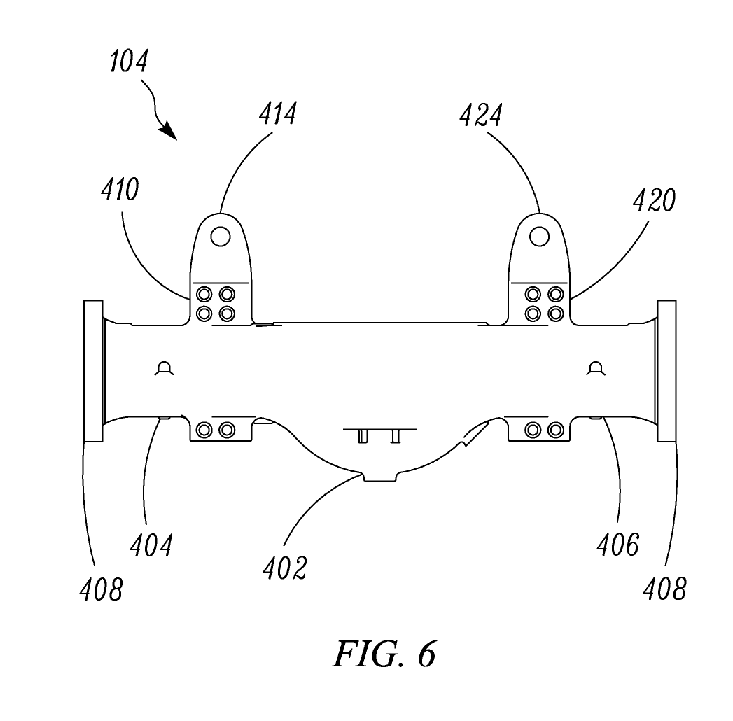

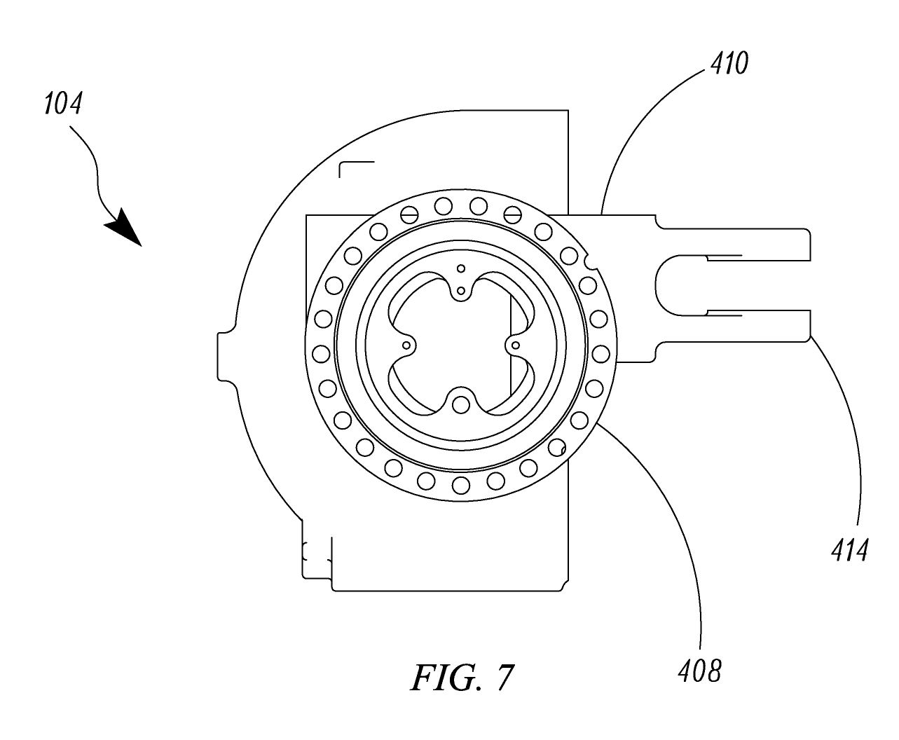

FIGS. 4-7 illustrate different views of the axle 104. The axle 104 may include a differential housing 402 for accommodating a differential in the machine 100. The axle 104 may also include a first arm 404 and a second arm 406 extending from the differential housing 402. The first arm 404 and the second arm 406 may be extending towards the first side 208 and the second side 210 of the chassis 114 respectively. Further, the axle 104 may include drive shafts connected to the differential and housed within the first arm 404 and the second arm 406. The drive shafts may rotate with power derived from the power source in the machine 100. In an embodiment, the machine 100 may have an electric drive with electric propulsion motors connected to the pair of wheels 102. The axle 104 may be in the form of a tubular member disposed between the pair of wheels 102 and housing the electric propulsion motors.

The axle 104 may further include a pair of wheel mounts 408 disposed at distal ends of the first arm 404 and the second arm 406. The wheel mounts 408 may be adapted to receive the pair of wheels 102 in the machine 100. The pair of wheels 102 may be attached to the drive shafts at the wheel mounts 408 in the axle 104 by means of fastening members like nuts and bolts, etc. The differential housed in the differential housing 402 of the axle 104 may allow the drive shafts and thus the pair of wheels 102 connected to the drive shafts to rotate at different speeds while steering the machine 100.

Further, the axle 104 may include a first support portion 410 disposed in the first arm 404 and a second support portion 420 disposed in the second arm 406. The first and the second support portions 410, 420 may be configured to receive the first and the second steering actuators 302, 304 in the steering arrangement 300. Further, the first and the second support portions 410, 420 may have a first aperture 412 and a second aperture 422 respectively formed therein. The front frame member 202 may also include a coinciding first aperture and a coinciding second aperture (not illustrated). A fastening member, which may be any one of a nuts and bolts, screws, etc., may pass through the first aperture 412 and the coinciding first aperture and the second aperture 422 and the coinciding second aperture to ultimately mount the axle 104 to the front frame member 202 of the frame 200.

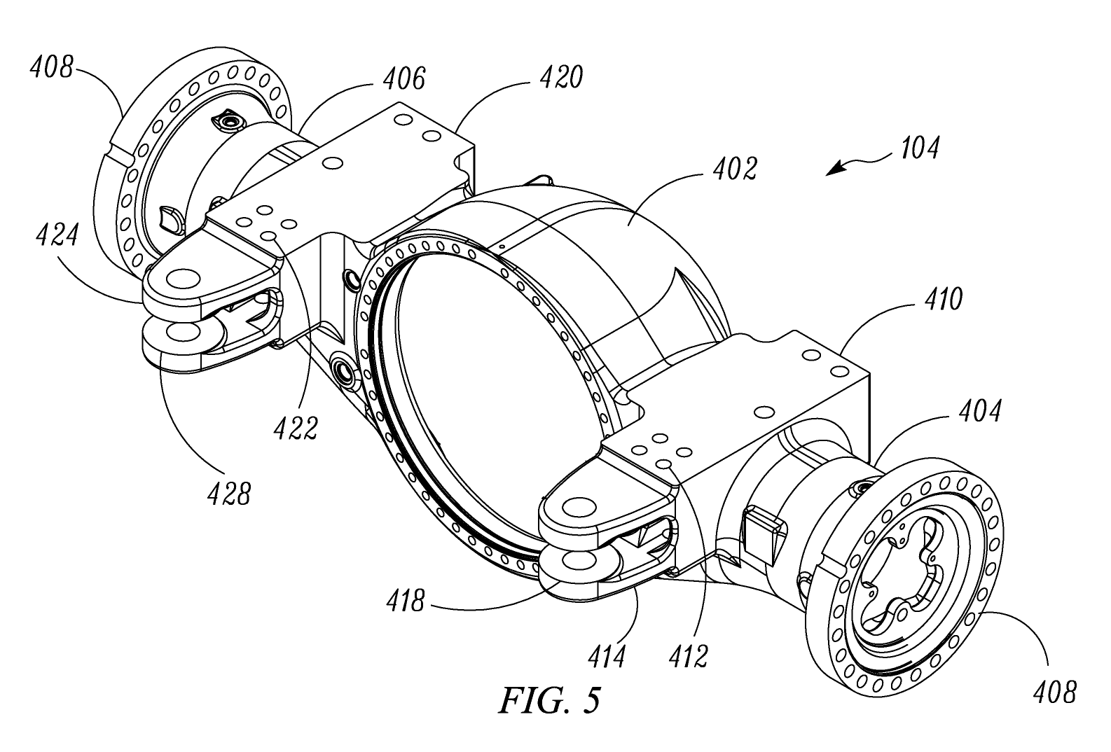

Further, the first support portion 410 and the second support portion 420 may provide a first bracket 414 and a second bracket 424, respectively. In an embodiment of the present disclosure, as illustrated in FIG. 4, the first bracket 414 may be removably connected to the first support portion 410 of the axle 104. Similarly, the second bracket 424 may be removably connected to the second support portion 420 of the axle 104. In an alternative embodiment, as illustrated in FIG. 5, the first bracket 414 and the second bracket 424 may be integrally connected with the first support portion 410 and the second support portion 420, respectively. The first bracket 414 and the second bracket 424 may be integrally formed during manufacturing of the axle 104. Alternatively, the first and the second brackets 414, 424 may welded later on to the first and the second support portions 410, 420 respectively.

To removably connect the first bracket 414, the first support portion 410 may include a first mounting hole 416 disposed in a lateral side 411 of the axle 104. The first mounting hole 416 may be configured to removably accommodate the first bracket 414 in the first support portion 410. The first bracket 414 may be disposed in the first mounting hole 416 and affixed to the axle 104 by means of the same fastening member passing through the first aperture 412 in the first support portion 410 and a corresponding first aperture 417 in the first bracket 414. Similarly, the second bracket 424 may be removably accommodated in a second mounting hole 426 and affixed by fastening member passing through the second aperture 422 and a corresponding second aperture 427 in the second bracket 424.

Further, the first and the second brackets 414, 424 may provide a first joint 418 and a second joint 428. In an embodiment, the first and the second joints 418, 428 may be clevis shaped joints. However, it may be contemplated that the first and the second joints 418, 428 may instead be a pin joint, a universal joint or the like. The first and the second joints 418, 428 may be configured to receive the pair of steering actuators 302, 304 in the steering arrangement 300. The first and the second joints 418, 428 may either be a single ear or a double ear clevis joints. Correspondingly, the first end 306 of the steering actuators 302, 304 may have the double ear or the single ear clevis joints. In other embodiments, the first and the second support portions 410, 420 may use a pivotal joint to directly mount the steering actuators 302, 304 to the axle 104.

Specifically, the first steering actuator 302 may be pivotally connected from the first end 306 to the first bracket 414 at the first joint 418. Also, the first steering actuator 302 may be connected from the second end 308 to the rear frame member 204. Thus, the first steering actuator 302 may be supported in the first support portion 410 of the axle 104 and thus to the front frame member 202. Similarly, the second steering actuator 304 may be pivotally connected from the first end 306 to the second bracket 424 and from the second end 308 to the rear frame member 204.

### INDUSTRIAL APPLICABILITY

The present disclosure is applicable to many machines, for example, wheel loaders which are commonly used in construction sites, mines and quarries. Typically, such machines employ a steering arrangement with the articulation joint between the front frame member and the rear frame member. Further, the steering actuators may be connected between the front frame member and the rear frame member. Such steering arrangement may not provide efficient steering for the machine. Further, this may take up some space above the axle for installation of hydraulic lines for lift and tilt cylinders for the linkage arm.

The machine 100 of the present disclosure may include the steering arrangement 300, in which the pair of steering actuators 302, 304 mounted to the axle 104 instead of directly to the front frame member 202 in the machine 100. This affords some space above the axle 104 to install the hydraulic lines in the machine 100. The steering arrangement 300 may rotate the axle 104, which in turn exhibit the rotation of the front frame member 202 relative to the rear frame member 204 and thus achieve steering in the machine 100.

When the machine 100 needs to be steered, the operator use the steering control 112 in the operator cab 110. The steering control 112 issues a steering signal for the hydraulic circuit. The hydraulic circuit provides a supply of hydraulic fluid to the steering actuators 302, 304. When the machine 100 needs to be steered towards the direction of first side 208, the hydraulic fluid is supplied to the second steering actuator 304 to move the extendible rod 312 away from inside of the cylinder 310. The second steering actuator 304 connected at the second joint 428 may move the axle 104 causing the front frame member 202 to rotate relative to the rear frame member 204 and resulting in steering of the machine 100. Conversely, the first steering actuator 302 may be actuated to steer the machine 100 towards the direction of second side 210.

Although the embodiments of this disclosure as described herein may be incorporated without departing from the scope of the following claims, it will be apparent to those skilled in the art that various modifications and variations can be made. While this disclosure has been written, largely in terms of wheel loader, it will be recognized that the disclosure is applicable to related vehicles. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. An axle for a steering arrangement, the axle comprising:
a differential housing;
a first arm extending from the differential housing;
a second arm extending from the differential housing;
a first support portion disposed in the first arm, the first support portion configured to receive a first steering actuator; and
a second support portion disposed in the second arm, the second support portion configured to receive a second steering actuator.

2. The axle of claim 1 further includes a first bracket removably connected to the first support portion on the axle, wherein the first bracket is configured to receive the first steering actuator.

3. The axle of claim 2, wherein the first support portion includes a first mounting hole to receive the first bracket.

4. The axle of claim 2, wherein the first bracket includes a first joint for pivotally connecting the first steering actuator.

5. The axle of claim 4, wherein the first joint is a clevis shaped joint.

6. The axle of claim 1 further includes a second bracket removably connected to the second support portion on the axle, wherein the second bracket is configured to receive the second steering actuator.

7. The axle of claim 6, wherein the second support portion includes a second mounting hole to receive the second bracket.

8. The axle of claim 6, wherein the second bracket includes a second joint for pivotally connecting the second steering actuator.

9. The axle of claim 8, wherein the second joint is a clevis shaped joint.

10. The axle of claim 1 further includes a first bracket integrally connected with the first support portion, wherein the first bracket is configured to receive the first steering actuator.

11. The axle of claim 1 further includes a second bracket integrally connected with the second support portion, wherein the second bracket is configured to receive the second steering actuator.

12. The axle of claim 1, wherein the first support portion and the second support portion include a first aperture and a second aperture respectively, the first aperture and the second aperture configured to mount the axle to a frame.

13. A chassis comprising:
a front frame member;
a rear frame member;
an articulation joint connecting the front frame member and the rear frame member; and
an axle including:
a first arm;
a second arm;
a first support portion disposed in the first arm, the first support portion configured to receive a first steering actuator; and
a second support portion disposed in the second arm, the second support portion configured to receive a second steering actuator.

14. The chassis of claim 13 further includes a first bracket and a second bracket removably connected to the first support portion and the second support portion on the axle, wherein the first bracket and the second bracket are configured to receive the first steering actuator and the second steering actuator respectively.

15. The chassis of claim 14, wherein the first bracket and the second bracket include a first joint and a second joint for pivotally connecting the first steering actuator and the second steering actuator respectively.

16. The chassis of claim 13 further includes a first bracket and a second bracket integrally connected with the first support portion and the second support portion, wherein the first bracket and the second bracket are configured to receive the first steering actuator and the second steering actuator respectively.

17. A machine having a pair of wheels acting as ground engaging members, the machine comprising:
an axle disposed between the pair of wheels, the axle including:
a first arm;
a second arm;
a first support portion disposed in the first arm; and
a second support portion disposed in the second arm;
a frame supported on the axle; the frame including:
a front frame member;
a rear frame member; and
an articulation joint connecting the front frame member and the rear frame member;
a first steering actuator pivotally connected between the first support portion and the rear frame member; and
a second steering actuator pivotally connected between the second support portion and the rear frame member.

18. The machine of claim 17 further includes a first bracket and a second bracket removably connected to the first support portion and the second support portion on the axle, wherein the first bracket and the second bracket are configured to receive the first steering actuator and the second steering actuator respectively.

19. The machine of claim 18, wherein the first bracket and the second bracket include a first joint and a second joint for pivotally connecting the first steering actuator and the second steering actuator respectively.

20. The machine of claim 17 further includes a first bracket and a second bracket integrally connected with the first support portion and the second support portion, wherein the first bracket and the second bracket are configured to receive the first steering actuator and the second steering actuator respectively.
